(19) United States
(12) Patent Application Publication
(10) Pub. No.: US 2026/0067623 A1
(43) Pub. Date: Mar. 5, 2026

(54) DIAGNOSTIC TESTING OF EAR-WORN DEVICES

(71) Applicant: Fortell Research Inc., New York, NY (US)

(72) Inventors: Matthew de Jonge, Brooklyn, NY (US); Nicholas Morris, Brooklyn, NY (US); Kevin Franck, Concord, MA (US); Abraham Neben, Hamden, CT (US); Ryan terMeulen, Watertown, MA (US); Matthew Slotkin, Brooklyn, NY (US)

(21) Appl. No.: 19/315,357

(22) Filed: Aug. 29, 2025

Related U.S. Application Data
(60) Provisional application No. 63/689,072, filed on Aug. 30, 2024.

(51) Int. Cl. H04R 25/00; H04R 1/10

(52) U.S. Cl. CPC H04R 25/305; H04R 1/1025; H04R 25/554; H04R 2225/31; H04R 2225/41

(57) ABSTRACT

A system may be configured to diagnostically test ear-worn devices when the ear-worn devices are in a charging case by generating test sound signals from receivers of the ear-worn devices, receiving the test sound signals at microphones of the ear-worn devices, determining levels of audio signals originating from the microphones of the ear-worn devices based on receiving the test sound signals, determining, based on the levels of the audio signals originating from the microphones of the ear-worn devices, that there is a fault, and based on determining that there is the fault, generating a notification.

### BACKGROUND

### Field

The present disclosure relates to diagnostic testing of ear-worn devices.

### Related Art

Ear-worn devices such as hearing aids may be used to help those who have trouble hearing to hear better. Typically, ear-worn devices amplify received sound. Some ear-worn devices enhance incoming sound.

### SUMMARY

One difficulty with ear-worn devices such as hearing aids is that debris may collect in orifices such as microphones and receivers of the ear-worn devices. Microphones or receivers may become damaged during daily use. This may degrade performance of the hearing aids, for example, by reducing the volume of the output from the hearing aids. It may be difficult for a wearer of hearing aids to determine when there is debris in their hearing aids. The inventors have developed technology for diagnostic testing of hearing aids and thereby determining whether debris or some other issue may be causing poor performance such as reduction in volume.

### BRIEF DESCRIPTION OF FIGURES

FIG. 1A illustrates a view of a hearing aid, in accordance with certain embodiments described herein;

FIG. 1B illustrates another view of the hearing aid of FIG. 1A, in accordance with certain embodiments described herein;

FIG. 2 illustrates a charging case for hearing aids, in accordance with certain embodiments described herein;

FIG. 3 illustrates a charging case holding two hearing aids while the hearing aids and in the charging case, in accordance with certain embodiments described herein;

FIG. 4 illustrates a system for diagnostic testing of ear-worn devices, in accordance with certain embodiments described herein;

FIG. 5 illustrates circuitry in an ear-worn device, in accordance with certain embodiments described herein;

FIG. 6 illustrates circuitry in an ear-worn device, in accordance with certain embodiments described herein;

FIG. 7 illustrates circuitry in an ear-worn device, in accordance with certain embodiments described herein;

FIG. 8 illustrates a process for initiating diagnostic testing of ear-worn devices, in accordance with certain embodiments described herein;

FIG. 9 illustrates a process for initiating diagnostic testing of ear-worn devices, in accordance with certain embodiments described herein;

FIG. 10 illustrates a process for diagnostic testing of one or more ear-worn devices, in accordance with certain embodiments described herein;

FIG. 11 illustrates a process for diagnostic testing of one or more ear-worn devices, in accordance with certain embodiments described herein;

FIG. 12 illustrates a charging case for hearing aids, in accordance with certain embodiments described herein;

FIG. 13 illustrates a charging case for hearing aids, in accordance with certain embodiments described herein;

FIG. 14 illustrates a charging case for hearing aids, in accordance with certain embodiments described herein;

FIG. 15 illustrates a process for diagnostic testing of one or more ear-worn devices, in accordance with certain embodiments described herein;

FIG. 16 illustrates a process for diagnostic testing of one or more ear-worn devices, in accordance with certain embodiments described herein;

### DETAILED DESCRIPTION

The aspects and embodiments described above, as well as additional aspects and embodiments, are described further below. These aspects and/or embodiments may be used individually, all together, or in any combination of two or more, as the disclosure is not limited in this respect.

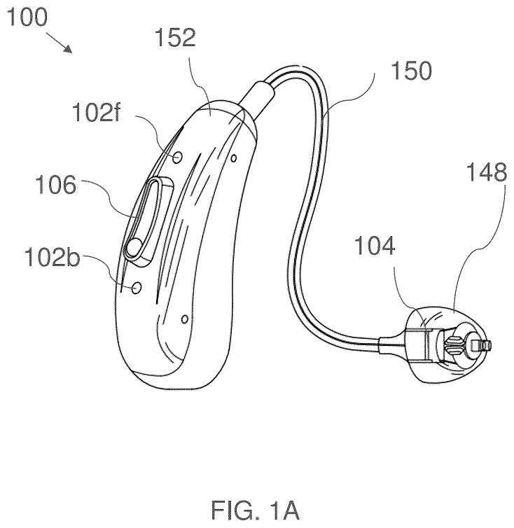

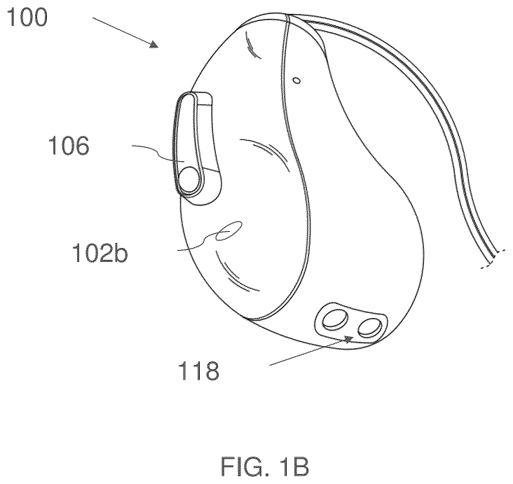

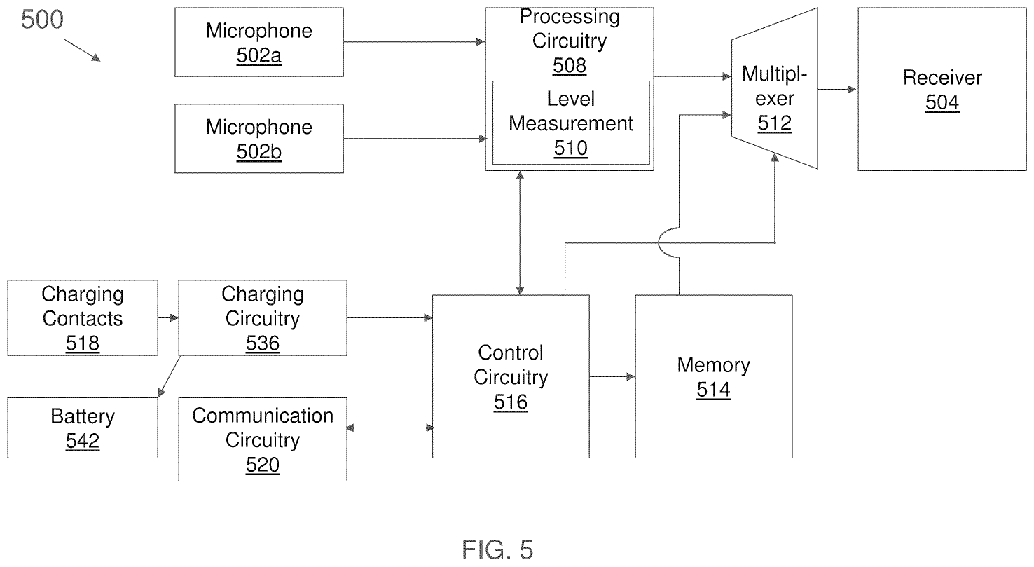

FIG. 1A illustrates a view of a hearing aid 100, in accordance with certain embodiments described herein. The hearing aid 100 may be any of the ear-worn devices or hearing aids described herein. The hearing aid 100 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid 100 includes a body 152, a receiver wire 150, a receiver 104, and a dome 148. The body 152 is coupled to the receiver wire 150 and the receiver wire 150 is coupled to the receiver 104. The dome 148 is placed over the receiver 104. The body 152 includes a front microphone 102f, a back microphone 102b, and a user input device 106. The body 152 additionally includes circuitry not illustrated in FIG. 1A. For example, any or all of the circuitry illustrated in FIGS. 5-7 (aside from the receiver) may be included in the body 152. When the hearing aid 100 is worn, the front microphone 102f may be closer to the front of the wearer and the back microphone 102b may be closer to the back of the wearer. The front microphone 102f and the back microphone 102b may be configured to receive sound signals and generate audio signals based on the sound signals. The user input device 106 (e.g., a button) may be configured to control certain functions of the hearing aid 100, such as volume, activation of neural network-based denoising, etc.

The receiver wire 150 may be configured to transmit audio signals from the body 152 to the receiver 104. The receiver 104 may be configured to receive audio signals (i.e., those audio signals generated by the body 152 and transmitted by the receiver wire 150) and generate sound signals based on the audio signals. The dome 148 may be configured to fit tightly inside the wearer's ear and direct the sound signals produced by the receiver 104 into the ear canal of the wearer.

FIG. 1B illustrates another view of the hearing aid 100, in accordance with certain embodiments described herein. FIG. 1B illustrates charging contacts 118 of the hearing aid 100.

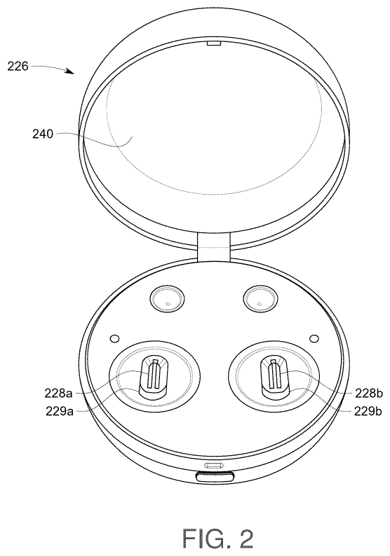

FIG. 2 illustrates a charging case 226 for hearing aids (of which the hearing aid 100 may be an example), in accordance with certain embodiments described herein. The charging case 226 may be configured for storage of hearing aids, carrying of hearing aids, and charging of hearing aids. The charging case 226 includes a lid 240, two receptacles 229a and 229b each for holding the body of a hearing aid (e.g., the body 152), and two receptacles 231a and 231b each for holding the receiver of a hearing (e.g., the receiver 104). The receptacle 229a includes charging contacts 228a and the receptacle 229b includes charging contacts 228b. When a hearing aid 100 is placed in one of the receptacles 229a or 229b, the charging contacts 118 on the hearing aid 100 may contact the charging contacts 228a or 229b (respectively) in the receptacle 229a or 229b of the charging case 226. Power may then flow from a battery (not illustrated) in the charging case 226, through the charging contacts 228a or 228b of the charging case 226, through the charging contacts 118 of the hearing aid 100, and to a battery (not illustrated) in the hearing aid 100, thereby charging it. Charging circuitry in the hearing aid 100 may facilitate charging of the battery in the hearing aid 100.

While FIG. 2 illustrates an embodiment including separate receptacles configured for holding the body and receiver of a hearing aid, it should be appreciated that some embodiments may include one receptacle configured for holding both the body and receiver of a hearing aid.

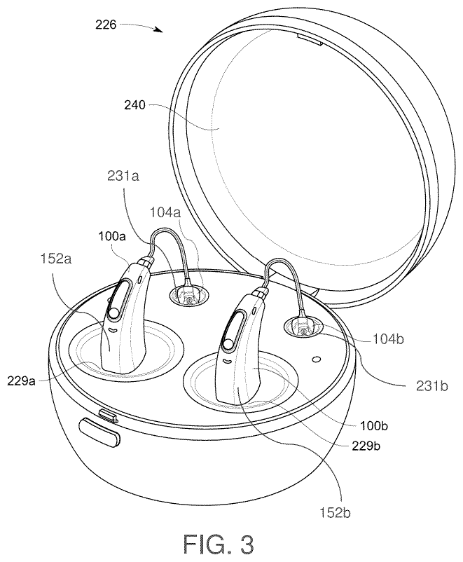

FIG. 3 illustrates the charging case 226 holding two hearing aids 100a and 100b while the hearing aids 100a and 100b are in the charging case 228, in accordance with certain embodiments described herein. The hearing aid 100a may be configured for wearing on the right ear and the hearing aid 100b may be configured for wearing on the left ear. As illustrated the receptacles 229a and 229b hold the bodies 152a and 152b of the hearing aids 100a and 100b, respectively, while the receptacles 231a and 231b hold the receivers 104a and 104b of the hearing aids 100a and 100b, respectively. As described above, other embodiments may include one receptacle for the body 152 and receiver 104 of each hearing aid 100, while still other embodiments may include indentations where the receivers 104 may sit. Positioning the receivers 104 in a consistent way in the charging case 226 may help with performing better diagnostic testing.

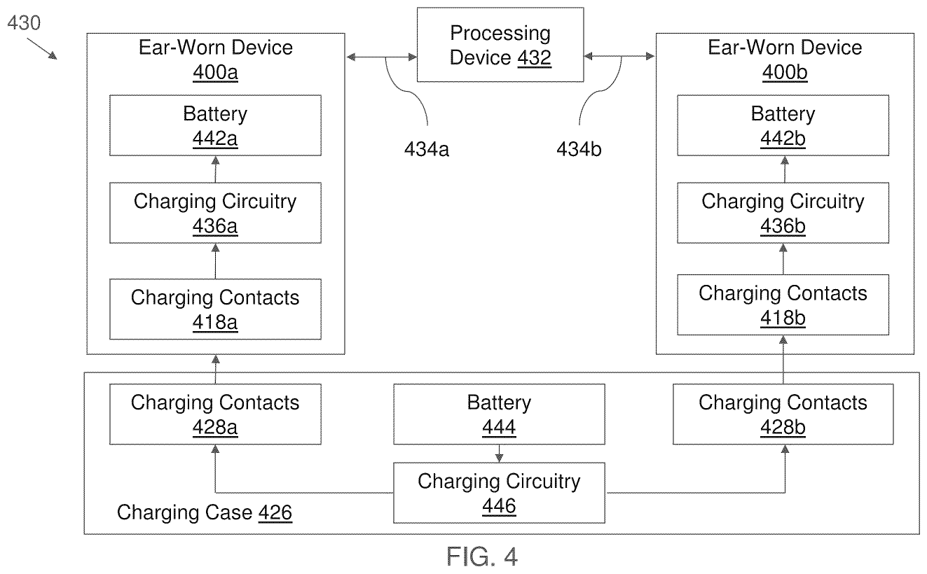

FIG. 4 illustrates a system 430 for diagnostic testing of ear-worn devices 400a and 400b, in accordance with certain embodiments described herein. The system 430 includes the ear-worn devices 400a and 400b, a charging case 426 (an example of which may be the charging case 226), and a processing device 432 (e.g., a smartphone, tablet, or laptop). The ear-worn devices 400a and 400b may be, for example, hearing aids (e.g., the hearing aid 100). The ear-worn device 400a may be configured for wearing on the right ear and the ear-worn device 400b may be configured for wearing on the left ear. The ear-worn device 400a includes charging contacts 418a, charging circuitry 436a, and a battery 442a. The charging contacts 418a are coupled to the charging circuitry 436a, and the charging circuitry 436a is coupled to the battery 442a. The ear-worn device 400b includes charging contacts 418b, charging circuitry 436b, and a battery 442b. The charging contacts 418b are coupled to the charging circuitry 436b, and the charging circuitry 436b is coupled to the battery 442b. The charging contacts 118 may be an example of the charging contacts 418a and 418b. The charging case 4126 includes a battery 444, charging circuitry 446, charging contacts 428a, and charging contacts 428b (examples of which may be the charging contacts 228a and 228b, respectively). The charging contacts 428a and charging contacts 428b are illustrated as electrically coupled to the charging contacts 418a and 418b, respectively, for example, based on contact. The charging circuitry 446 in the charging case 426 may be configured to facilitate flow of power from the battery 444 to the charging contacts 428a and 428b. The charging circuitry 436a may facilitate flow of power from the charging contacts 418a to the battery 442a. The charging circuitry 436b may facilitate flow of power from the charging contacts 418b to the battery 442b. Thus, the battery 444 in the charging case 426 may charge the batteries 442a and 442b in the ear-worn devices 400a and 400b, respectively.

The ear-worn device 400a is in wireless communication with the processing device 432 over a wireless communication link 434a and the ear-worn device 400b is in wireless communication with the processing device 432 over a wireless communication link 434b. The wireless communication links 434a and 434b may be, for example, Bluetooth or NFMI communication links. The ear-worn devices 400a and 400b may transmit information and/or commands to the processing device 432 over the wireless communication links 434a and 434b, respectively, and the processing device 432 may transmit information and/or commands to the ear-worn devices 400a and 400b over the wireless communication links 434a and 434b, respectively.

FIG. 5 illustrates circuitry in an ear-worn device 500, in accordance with certain embodiments described herein. The ear-worn devices 400a and 400b may be examples of the ear-worn device 500, which may be, for example, a hearing aid (e.g., the hearing aid 100). It should be appreciated that the ear-worn device may include more circuitry than illustrated in FIG. 5. The ear-worn device 500 includes a microphone 502a, a microphone 502b, processing circuitry 508, a receiver 504, a multiplexer 512, memory 514, control circuitry 516, charging circuitry 536, charging contacts 518, a battery 542, and communication circuitry 520. The processing circuitry 508 includes level measurement circuitry 510.

The processing circuitry 508 is configured to receive the outputs from the microphones 502a and 502b. The multiplexer 512 is configured to receive one input that is an output from the processing circuitry 508, one input that is an output from the memory 514, and a control input that is output from the control circuitry 516. The receiver 504 is configured to receive the output from the multiplexer 512. The control circuitry 516 and the processing circuitry 508 are coupled to each other, the charging circuitry 536 and the control circuitry 516 are coupled to each other, and the communication circuitry 520 and the control circuitry 516 are coupled to each other. The charging contacts 518 are coupled to the charging circuitry 536. The charging circuitry 536 is coupled to the battery 542.

The microphones 502a and 502b may be configured to receive sound signals and generate audio signals based on the sound signals. In some embodiments, when the ear-worn device 500 is worn by a wearer, the microphone 502a may be a front microphone that is closer to the front of the wearer and the microphone 502b may be a back microphone that may be closer to the back of the wearer. The microphones 102f and 102b may be examples of the microphones 502a and 502b, respectively. In some embodiments, the ear-worn device 500 may include more than two microphones.

The processing circuitry 508 may be configured to process audio signals received from the microphones 502a and 502b. In some embodiments, the processing circuitry 508 may include analog processing circuitry. The analog processing circuitry may be configured to perform analog processing. For example, the analog processing circuitry may be configured to perform one or more of analog preamplification, analog filtering, and analog-to-digital conversion. In some embodiments, the processing circuitry 508 may include digital processing circuitry. The digital processing circuitry may be configured to perform digital processing. For example, the digital processing circuitry may be configured to perform one or more of wind reduction, input calibration, anti-feedback processing, wide-dynamic range compression, and output calibration. In some embodiments, the processing circuitry 508 may include beamforming circuitry. The beamforming circuitry may be configured to perform beamforming, for example, focusing on sounds received from in front of the wearer. In some embodiments, the processing circuitry 508 may include enhancement circuitry configured to enhance the digital-processed audio signals, for example, by denoising and/or spatial focusing. For example, the enhancement circuitry may include neural network circuitry configured to implement a neural network trained to do denoising and/or spatial focusing. In some embodiments, portions or all of the processing circuitry 508 may be configured to process audio signals in the frequency-domain. In such embodiments, the processing circuitry 508 may include short-time Fourier transform (STFT) circuitry configured to convert short windows of audio signals from time domain to frequency domain, and inverse STFT (iSTFT) circuitry configured to convert short windows of audio signals from frequency domain to time domain.

The processing circuitry 508 further includes the level measurement circuitry 510. The level measurement circuitry 510 may be configured to measure the level of an audio signal. In particular, the level measurement circuitry 510 may be configured to separately measure the level of the audio signal originating from the microphone 502a and the level of the audio signal originating from the microphone 502b. (Generally, measuring the level of an audio signal originating from a microphone may include measuring the level of an audio signal generated by a microphone, or measuring the level of a processed or downstream version of an audio signal generated by a microphone.) Different embodiments may include the level measurement circuitry 510 being configured to measure the level of an audio signal at different points in the processing circuitry 508 signal chain. In some embodiments, the level measurement circuitry 510 may be configured to measure the level of an audio signal originating directly from one of the microphones 502a and 502b. In some embodiments, the level measurement circuitry 510 may be configured to use feedback cancellation circuitry to measure the level of an audio signal.

When measuring the level of an audio signal, in some embodiments, prior to the level measurement circuitry 510 determining the level of the audio signal, the audio signal may be normalized. In some embodiments, prior to determining the level of the audio signal, the audio signal may be averaged over time. In some embodiments, prior to determining the level of the audio signal, the audio signal may be squared. In some embodiments, prior to determining the level of the audio signal, the audio signal may be squared and its square root taken. In some embodiments, prior to determining the level of the audio signal, the audio signal may be converted to logarithmic units (e.g., decibels). In some embodiments, a combination of these operations may be performed. The level of the audio signal may also be considered or referred to as the volume of the audio signal, although as described above, different types of units may be used and still considered to be the volume.

The multiplexer 512 may be configured to output to the receiver 504 either the output of the processing circuitry 508 or an output from the memory 514, based on a control signal received from the control circuitry 516.

The receiver 504 (an example of which may be the receiver 104) may be configured to receive audio signals and generate sound signals based on the audio signals. The receiver 504 may also be configured to implement digital-to-analog conversion prior to the playing back.

The memory 514 may be configured to store a test audio waveform (e.g., a chirp). In some embodiments, the test audio waveform may be transmitted to the ear-worn device 500 from a processing device (e.g., the processing device 432) at an earlier time, and stored in the memory 514.

The control circuitry 516 may be configured to control operations of the circuitry in the ear-worn device 500. For simplicity, only connections between the control circuitry 516 and other components that are relevant to the technology described herein are illustrated. However, it should be appreciated that the control circuitry 516 may be configured to control other components and may be configured to perform other control operations than those illustrated and described herein.

As described with reference to FIG. 4, the charging circuitry 536 may be configured to receive power from a charging case (e.g., the charging case 426 and/or 226) through the charging contacts 518, and thereby power up the battery 542. The charging contacts 118, 418a, and 418b may be examples of the charging contacts 518. The batteries 442a and 442b may be examples of the battery 542. The charging circuitry 436a and 436b may be examples of the charging circuitry 536.

The communication circuitry 520 may be configured to communicate with other devices, such as smartphones, tablets, or laptops (e.g., the processing device 432) over wireless communication links (e.g., the wireless communication links 434a and 434b). For example, the wireless communication link may be Bluetooth or NFMI communication links.

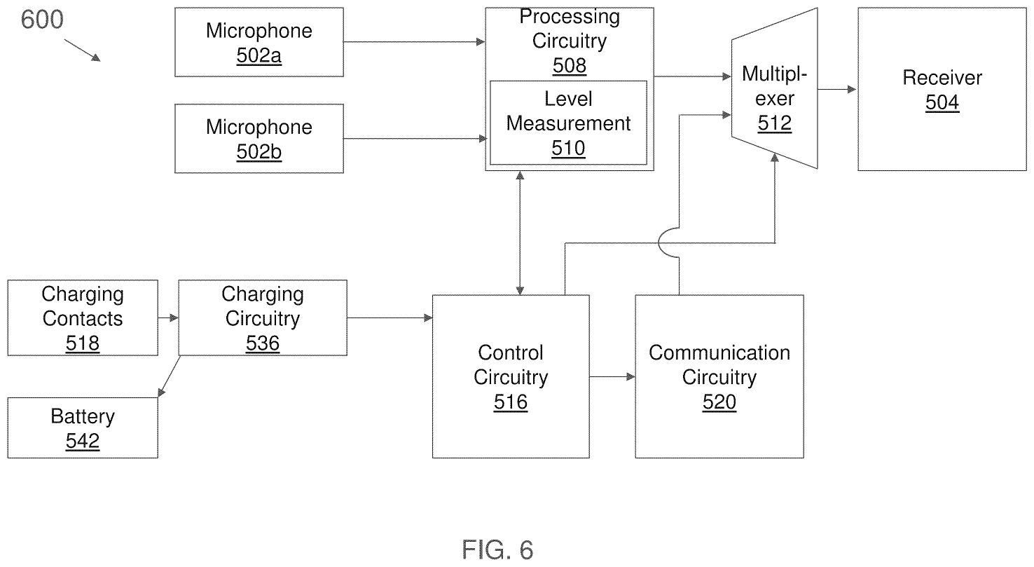

FIG. 6 illustrates circuitry in an ear-worn device 600, in accordance with certain embodiments described herein. The ear-worn devices 400a and 400b may be examples of the ear-worn device 600, which may be, for example, a hearing aid (e.g., the hearing aid 100). It should be appreciated that the ear-worn device may include more circuitry than illustrated in FIG. 6. The circuitry in the ear-worn device 600 corresponds to the circuitry in the ear-worn device 500, except that the multiplexer 512 is configured to receive one input that is an output from the processing circuitry 508, one input that is an output from the communication circuitry 520, and a control input that is output from the control circuitry 516. The ear-worn device 600 lacks the memory 514 storing the test audio waveform (but may include memory storing other data).

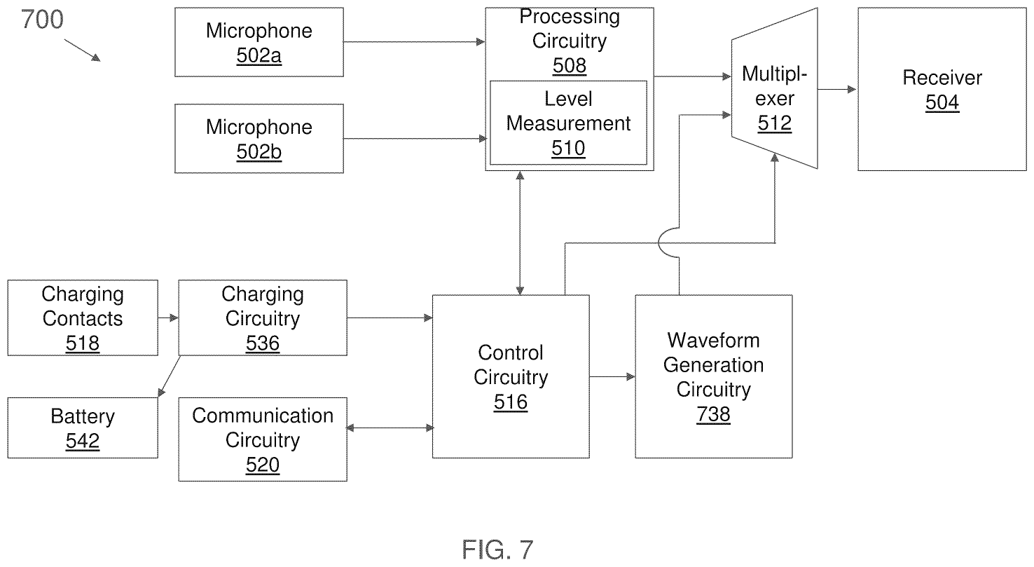

FIG. 7 illustrates circuitry in an ear-worn device 700, in accordance with certain embodiments described herein. The ear-worn devices 400a and 400b may be examples of the ear-worn device 700, which may be, for example, a hearing aid (e.g., the hearing aid 100). It should be appreciated that the ear-worn device may include more circuitry than illustrated in FIG. 7. The circuitry in the ear-worn device 700 corresponds the circuitry in the ear-worn device 500, except that the multiplexer 512 is configured to receive one input that is an output from the processing circuitry 508, one input that is an output from waveform generation circuitry 738, and a control input that is output from the control circuitry 516. The waveform generation circuitry 738 may be configured to generate a test audio waveform based on parameters received from the control circuitry 516. The ear-worn device 700 lacks the memory 514 storing the test audio waveform (but may include memory storing other data).

For normal operation of the ear-worn devices 500, 600, and 700, the control circuitry 516 may be configured to control the multiplexer 512 to output to the receiver 504 the output from the processing circuitry 508, such that the receiver 504 outputs processed (e.g., amplified, focused, and/or denoised) audio signals generated based on sound signals received by the microphones 502a and 502b from the environment. For diagnostic testing of the ear-worn devices 500, the control circuitry 516 may be configured to control the multiplexer 512 to output to the receiver 504 the test audio waveform stored in the memory 514. For diagnostic testing of the ear-worn device 600, the control circuitry 516 may be configured to control the multiplexer to output to the receiver 504 the test audio waveform received from the communication circuitry 520. For diagnostic testing of the ear-worn device 700, the control circuitry 516 may be configured to control the multiplexer to output to the receiver 504 the test audio waveform generated by the waveform generation circuitry 738. In some embodiments, the test audio waveform may be a chirp. The receiver 504 may be configured to output the test audio waveform as a test sound signal, which may be received by the microphones 502a and 502b and converted to audio signals. The level measurement circuitry 510 may be configured to measure the levels of each of the audio signals originating from the microphones 502a and 502b (e.g., in response to the test sound waveform from the receiver 504). Further description of diagnostic testing may be found below.

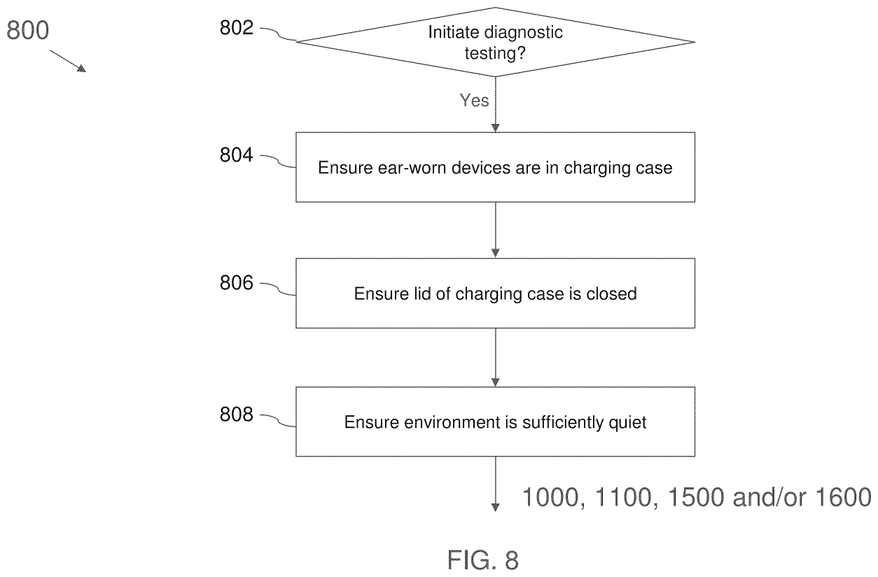

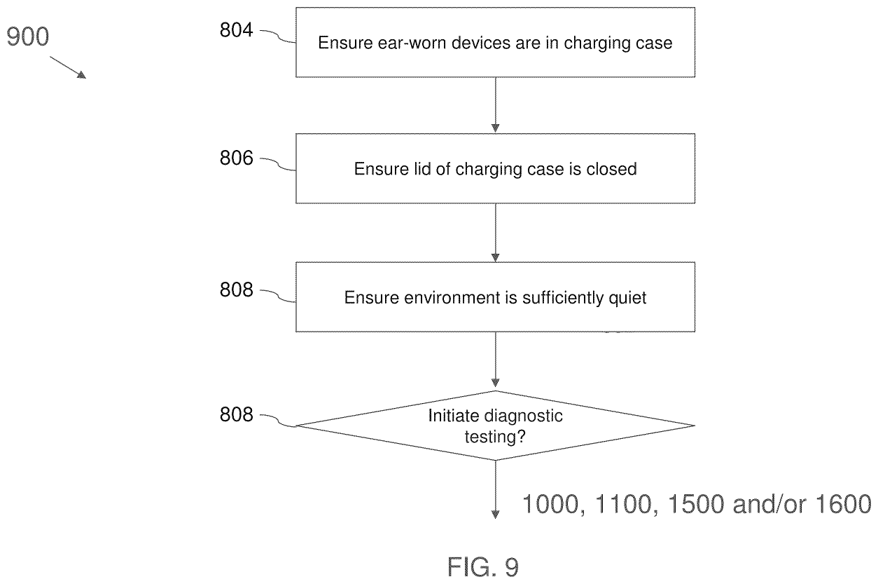

FIGS. 8 and 9 illustrate processes 800 and 900, respectively, for initiating diagnostic testing of ear-worn devices, in accordance with certain embodiments described herein. The ear-worn devices may be, for example, hearing aids. The hearing aids 100a and 100b and the ear-worn devices 500, 600, and 700 may be examples of the ear-worn devices diagnostically tested as part of the processes 800 and 900. One of the ear-worn devices may be configured for wearing on a right ear, and one of the ear-worn devices may be configured for wearing on a left ear. The processes 800 and 900 may be performed by a system (e.g., the system 430) including ear-worn devices, a charging case (e.g., the charging case 226 and/or 426), and a processing device (e.g., the processing device 432). The processing device may be, for example, a smartphone, tablet, or laptop. The ear-worn devices may be in wireless communication with the processing device over wireless communication links (e.g., the wireless communication links 434a and 434b), which may be, for example, Bluetooth or NFMI wireless communication links.

Turning to FIG. 8, at step 802, the system determines whether to initiate diagnostic testing. In some embodiments, the system may determine to initiate diagnostic testing based on receiving a user selection to diagnostically test the ear-worn devices. For example, the processing device may display a diagnostic testing option as part of a graphical user interface (GUI) displayed by the display screen of the processing device, and the system may determine to initiate diagnostic testing based on receiving a user selection of the option. The GUI may be part of an app run by the processing device for controlling operation of the ear-worn devices. In some embodiments, the system may determine whether to initiate diagnostic testing automatically. For example, the processing device may determine to initiate diagnostic testing periodically, based on a predetermined amount of time elapsing. In such embodiments, the processing device may periodically push an option to the user to initiate diagnostic testing, the user may select the option to initiate diagnostic testing, and the system may determine to initiate diagnostic testing based on receiving a user selection of the option. Alternatively, the processing device may initiate diagnostic testing periodically, without a user selection. In some embodiments, the processing device may determine to initiate diagnostic testing based on determining that a particular time of day has arrived. For example, the processing device may determine to initiate diagnostic testing at a particular time of a day, such as nighttime when the ear-worn devices are not typically worn. If the system determines to initiate diagnostic testing, the process 800 proceeds to step 804. If the system does not determine to initiate diagnostic testing, the process 800 remains at step 802.

At step 804, the system ensures that the ear-worn devices are in the charging case. This may be helpful because the charging case may provide a controlled environment, position, and orientation for the ear-worn devices, such that level measurements at different times may be comparable.

In some embodiments, ensuring that the ear-worn devices are in the charging case may include providing a notification to place the ear-worn devices in the charging case. In some embodiments, the processing device may display the notification on its display screen. The process 800 may then proceed to step 806.

In some embodiments, ensuring that the ear-worn devices are in the charging case may include determining whether the ear-worn devices are in the charging case. In some embodiments, control circuitry (e.g., the control circuitry 516) in each ear-worn device may determine that the ear-worn device is in the charging case using charging circuitry (e.g., the charging circuitry 536) in the ear-worn device. In some embodiments, the charging circuitry may transmit a control signal to the control circuitry when the charging circuitry is receiving power through the charging contacts (e.g., the charging contacts 518), and the control circuitry may determine that the ear-worn device is in the charging case based on the control signal. In some embodiments, the control circuitry may control communication circuitry (e.g., the communication circuitry 520) to transmit an indication to the processing device over the wireless communication link (e.g., the wireless communication link 434a and/or 434b) that the ear-worn device is in the charging case. The system may determine that the ear-worn devices are in the charging case when the processing device receives indications from each respective ear-worn device that it is in the charging case. If the system determines that the ear-worn devices are in the charging case, the process 800 may proceed to step 806. In some embodiments, if the system determines that the ear-worn devices are not in the charging case, the system may wait for a period of time (e.g., a predetermined period of time or a user-selected period of time) and then the process 800 may proceed to step 802, step 806, or remain at step 804. In some embodiments, if the system determines that the ear-worn devices are not in the charging case, the system may provide a notification to place the ear-worn devices in the charging case, and then the process 800 may proceed to step 802, step 806, or remain at step 804. In some embodiments, the processing device may display the notification on its display screen.

At step 806, the system ensures that the lid (e.g., the lid 240) of the charging case is closed. In some embodiments, ensuring that the lid of the charging case is closed may include providing a notification to close the lid (e.g., the lid 240) of the charging case. In some embodiments, the processing device may display the notification on its display screen. The process 800 may then proceed to step 808.

In some embodiments, ensuring that the lid of the charging case is closed may include determining if the lid of the charging case is closed. In some embodiments, the charging case may include one or more sensors configured to determine when the lid of the charging case is closed. For example, there may be a magnet in the lid and a magnetic sensor in the portion of the charging case that the lid couples to when closed. The charging case may further include communication circuitry that may be configured to transmit an indication to the processing device when the lid is closed. The system may determine if the lid of the charging case is closed based on the indication received by the processing device from the charging case. If the system determines that the lid of the charging case is closed, the process 800 may proceed to step 808. In some embodiments, if the system determines that the lid of the charging case is not closed, the system may wait for a period of time (e.g., a predetermined period of time or a user-selected period of time) and then the process 800 may proceed to step 802, step 808, or remain at step 806. In some embodiments, if the system determines that the lid of the charging case is not closed, the system may provide a notification to close the lid of the charging case, and then the process 800 may proceed to step 802, step 808, or remain at step 806. In some embodiments, the processing device may display the notification on its display screen.

At step 808, the system ensures that the environment (i.e., within the charging case) is sufficiently quiet. In some embodiments, ensuring that the environment is sufficiently quiet may include providing a notification to ensure that the environment is sufficiently quiet. In some embodiments, the processing device may display the notification on its display screen. The process 800 may then proceed to the process 1000, 1100, 1500, and/or 1600 for diagnostic testing.

In some embodiments, ensuring that the environment is sufficiently quiet may include determining if the environment is sufficiently quiet. In other words, determining if the environment is sufficiently quiet may include determining if the volume of the environment is below a threshold value. In some embodiments, this determination may include determining levels of audio signals originating from the one or more microphones of each of the one or more ear-worn devices when in the idle state (i.e., in the absence of test signals). In some embodiments, the system may use level measurement circuitry (e.g., the level measurement circuitry 510) in each ear-worn device to measure the levels of each of the audio signals originating from the microphones in response to the test sound waveform from each receiver. In some embodiments, the system may measure the levels of the audio signal originating directly from the microphones (e.g., rather than using feedback cancellation circuitry). In some embodiments, the system may be configured to compare the levels of each of the audio signals to a threshold value. If any of the levels, or a processed version of the levels (e.g., the mean, maximum, mode) is above a threshold value, the system may determine that the environment is not sufficiently quiet. If all of the levels are below the threshold value, or a processed version of all of the levels is below the threshold value, the system may determine that the environment is sufficiently quiet. In some embodiments, if the system determines that the environment is not sufficiently quiet, the system may wait for a period of time (e.g., a predetermined period of time or a user-selected period of time) and then the process 800 may proceed to step 802, proceed to the process 1000, 1100, 1500, and/or 1600 for diagnostic testing, or remain at step 808. In some embodiments, if the system determines that the environment is not sufficiently quiet, the system may provide a notification to ensure that the environment is sufficiently quiet, and then the process 800 may proceed to step 802, proceed to the process 1000, 1100, 1500, and/or 1600 for diagnostic testing, or remain at step 808. In some embodiments, the processing device may display the notification on its display screen. If the system determines that the environment is sufficiently quiet, the process 800 may proceed to the process 1000, 1100, 1500, and/or 1600 for diagnostic testing.

Turning to FIG. 9, the process 900 corresponds to the process 800, except that in the process 900, steps 804-808 occur before step 802. Thus, the system might only initiate diagnostic testing once it has ensured that the ear-worn devices are in their charging case, the lid is closed, and the environment is sufficiently quiet. It should this be appreciated that in embodiments which present a user option for initiating diagnostic testing at step 802 in the processes 800 and 900, the user option might only be available when the determinations at steps 804-808 are positive in some embodiments of the process 900, whereas in some embodiments of the process 800, the user option may always be available.

In some embodiments of the processes 800 and/or 900, step 804 may be absent. In other words, the process 800 may proceed to the diagnostic testing of processes 1000, 1100, 1500, and/or 1600 without ensuring that the ear-worn devices are in the charging case. In some embodiments, step 806 may be absent. In other words, the process 800 may proceed to the diagnostic testing of processes 1000, 1100, 1500, and/or 1600 without ensuring that the lid of the charging case is closed. In some embodiments, step 808 may be absent. In other words, the process 800 may proceed to the diagnostic testing of processes 1000, 1100, 1500, and/or 1600 without ensuring that the environment is sufficiently quiet. In some embodiments, more than one of these steps may be absent. It should be appreciated that steps 804, 806, and 808 (or any subset thereof) may occur in any order, or simultaneously.

The above description has described various example processes for initiating diagnostic testing of ear-worn devices. Some embodiments may include determining that the ear-worn devices are in the charging case. Some embodiments may include performing diagnostic testing of the ear-worn devices (e.g., generating the test sound signals from the receivers of the ear-worn devices) based on determining that the ear-worn devices are in the charging case. Some embodiments may include determining that the lid of the charging case is closed. Some embodiments may include performing diagnostic testing (e.g., generating the test sound signals from the receivers of the ear-worn devices) of the ear-worn devices based on determining that the lid of the charging case is closed. Some embodiments may include determining that the environment within the charging case is sufficiently. Some embodiments may include performing diagnostic testing (e.g., generating the test sound signals from the receivers of the ear-worn devices) of the ear-worn devices based on determining that the environment within the charging case is sufficiently quiet.

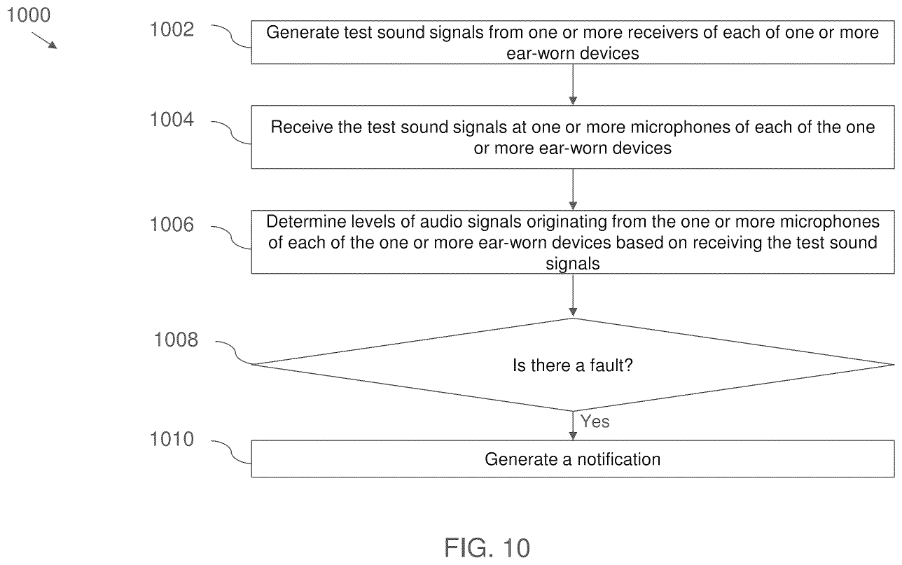

FIG. 10 illustrates a process 1000 for diagnostic testing of one or more ear-worn devices, in accordance with certain embodiments described herein. The ear-worn devices may be, for example, hearing aids. The hearing aids 100a and 100b and the ear-worn devices 500, 600, and 700 may be examples of the ear-worn devices diagnostically tested as part of the process 1000. The process 1000 may be performed by a system (e.g., the system 430) including one or more ear-worn devices, a charging case (e.g., the charging case 226 and/or 426), and a processing device (e.g., the processing device 432). The processing device may be, for example, a smartphone, tablet, or laptop. The ear-worn devices may be in wireless communication with the processing device over wireless communication links (e.g., the wireless communication links 434a and 434b), which may be, for example, Bluetooth or NFMI wireless communication links. The process 1000 may be performed while the ear-worn devices are in the charging case. Additionally, the process 1000 may be performed with the lid of the charging case closed.

Turning to FIG. 10, step 1002 of the process 1000 includes generating test sound signals from one or more receivers (e.g., the receivers 104 and/or 504) of each of the one or more ear-worn devices. As an example, with two ear-worn devices each having one receiver, two test sound signals may be generated. In some embodiments, the processing device may transmit commands over the wireless communication links to the ear-worn devices to initiate the diagnostic testing procedure. Generally, the test sound signals from the ear-worn devices might not overlap temporally. In some embodiments, the processing device may transmit one command to one ear-worn device to play the test sound signal, and then transmit another command to another ear-worn device to play the test sound signal, such that the two test sound signals do not overlap. In some embodiments, the processing device may transmit the commands to the ear-worn devices to play the test sound signal with delays so that the two test sound signals do not overlap. In some embodiments (e.g., the embodiment of the ear-worn device 500), communication circuitry (e.g., the communication circuitry 520) in an ear-worn device may receive the command from the processing device, and control circuitry (e.g., the control circuitry 510) in the ear-worn device may cause (e.g., using a multiplexer, such as the multiplexer 512) the receiver (e.g., the receiver 504) of the ear-worn device to receive a test audio waveform stored in memory (e.g., the memory 514) of the ear-worn device. In some embodiments (e.g., the embodiment of the ear-worn device 600), communication circuitry in an ear-worn device may receive the command from the processing device as well as a test audio waveform, and control circuitry in the ear-worn device may cause (e.g., using a multiplexer, such as the multiplexer 512) the receiver of the ear-worn device to receive the test audio waveform received by the communication circuitry. In some embodiments (e.g., the embodiment of the ear-worn device 700), communication circuitry in an ear-worn device may receive the command from the processing device, and control circuitry in the ear-worn device may cause (e.g., using a multiplexer, such as the multiplexer 512) the receiver of the ear-worn device to receive a test audio waveform from a waveform generation circuitry (e.g., the waveform generation circuitry 738). In some embodiments, the test audio waveform may be a chirp. The receiver may output the test audio waveform as the test sound signal. Each ear-worn device may output the test sound signal, such that two test sound signals may be generated at different times.

In some embodiments, the volume of the test sound signals may correspond to the maximum power output (MPO) of the ear-worn device. For example, the volume may be approximately 90 dB. However, if diagnostic testing is performed automatically, without a user selection to perform the diagnostic testing, in some embodiments the volume of the test sound signals may be lower than the MPO. This may help avoid the test sound signals disturbing or surprising anyone in the vicinity.

Step 1004 includes receiving the test sound signals at one or more microphones of each of the one or more ear-worn devices. The microphones may convert the test sound signals into audio signals. For example, if there are two ear-worn devices, and each ear-worn device includes two microphones (e.g., the microphones 502a and 502b), and two test sound signals are generated at step 1002, then a total of eight audio signals may be generated.

In some embodiments, the one or more ear-worn devices may include two ear-worn devices namely a first ear-worn device and a second ear-worn device. In such embodiments, steps 1002 and 1004 may include generating a first test sound signal from a first receiver of the first ear-worn device, receiving the first test sound signal at one or more first microphones of the first ear-worn device and at one or more second microphones of the second ear-worn device, and subsequent to generating and receiving the first test sound signal, generating a second test sound signal from a second receiver of the second ear-worn device, and receiving the second test sound signal at the one or more first microphones of the first ear-worn device and at the one or more second microphones of the second ear-worn device.

Step 1006 includes determining levels of audio signals originating from the one or more microphones of each of the one or more ear-worn devices based on receiving the test sound signals. In some embodiments, the system may use level measurement circuitry (e.g., the level measurement circuitry 510) in each ear-worn device to measure the levels of each of the audio signals originating from the microphones in response to the test sound waveform from each receiver. In some embodiments, the level measurement may be performed on audio signals directly from the one or more microphones. In some embodiments, the level measurement may be performed using feedback cancellation circuitry of the one or more ear-worn devices.

As described with reference to step 1004, if there are two ear-worn devices, each ear-worn device includes two microphones, and two test sound signals are generated at step 1002, then a total of eight audio signals may be generated, and eight level measurements may be obtained.

Step 1008 includes determining if there is a fault based on the levels of the audio signals originating from the one or more microphones of each of the one or more ear-worn devices. If the system determines that there is a fault, the process 1000 proceeds to step 1010. In some embodiments, the system may compare the levels obtained at step 1006 to previously-collected baseline levels. The baseline levels may have been previously collected during a baseline diagnostic testing according to the steps 1002-1006. For example, the baseline levels may be collected before the one or more ear-worn devices are worn by a wearer and/or prior to shipping of the one or more ear-worn devices to the wearer. These baseline levels may be stored in memory of the ear-worn device, on the processing device, or in the cloud (i.e., one or more servers accessible by the processing device). When the baseline measurements are stored on the ear-worn device, the ear-worn device may perform the comparison (e.g., using the processing circuitry 508) and transmit (e.g., using the communication circuitry 520) an indication of the comparison result to the processing device. Alternatively, the ear-worn device may transmit the new measurements as well as the baseline measurements to the processing device, which may perform the comparison. When the baseline measurements are stored on the processing device, the ear-worn device may transmit the new measurements to the processing device which may perform the comparison. When the baseline measurements are stored in the cloud, the ear-worn device may transmit the new measurements to the processing device, the processing device may receive the baseline measurements from the cloud, and the processing device may perform the comparison.

In some embodiments, the comparison may indicate whether there are faults with the receivers or whether there are faults with the microphones of the ear-worn devices. For example, consider that the levels of all the microphones in response to the test sound signal from the receiver of a first ear-worn device is the same at both the baseline diagnostic testing and the current diagnostic testing, but the levels of all four microphones in response to the test sound signal from the receiver of the second ear-worn device is lower, by at least a threshold level, at the current diagnostic testing than at the baseline diagnostic testing. This may indicate that there is a fault with the receiver of the second ear-worn device, such as debris clogging the receiver and causing the sound emitted to be lower in level during the later diagnostic testing than at the earlier diagnostic testing. As another example, consider that the levels from a first microphone on the first ear-worn device in response to the test sound signals from both receivers are lower, by at least a threshold level, at the current diagnostic testing than at the baseline diagnostic testing, but the levels from the other microphones in response to the test sound signals from both receivers are within a threshold of each other at the current diagnostic testing and at the baseline diagnostic testing. This may indicate that there is a fault with the first microphone on the first ear-worn device, such as debris clogging the microphone and causing the sound received by the microphone to be lower in level during the current diagnostic testing than at the earlier diagnostic testing.

It should be appreciated from the above that having multiple receivers and/or multiple microphones may be helpful in narrowing down which component may be faulty. Generally, determining that there is a fault may include determining whether one or more receivers of the one or more ear-worn devices are faulty or whether one or more microphones of the one or more ear-worn devices are faulty. For the scenario of determining that one or more receivers of the one or more ear-worn devices are faulty, consider that there is a first ear-worn device (e.g., a right ear-worn device) having a first receiver and a second ear-worn device (e.g., a left ear-worn device) having a second receiver. In some embodiments, determining that one or more receivers of the one or more ear-worn devices are faulty may include determining that the first receiver is faulty. In some embodiments, determining that the first receiver is faulty may include determining that the second receiver is not faulty. For the scenario of determining that one or more microphones of the one or more ear-worn devices are faulty, consider that there is a first ear-worn device having one or more first microphones (e.g., a front microphone and a back microphone) and a second ear-worn device having one or more second microphones. In some embodiments, determining that the one or more microphones of the one or more ear-worn devices are faulty may include determining that a first microphone (e.g., the front microphone) among the one or more first microphones is faulty. In some embodiments, determining that the first microphone among the one or more first microphones is faulty may include determining that other microphones among the one or more first microphones and the one or more second microphones are not faulty. In some embodiments, determining that the first microphone among the one or more first microphones is faulty may include determining that a second microphone among the one or more first microphones is not faulty.

In some embodiments, the system may be configured to perform a comparison of levels from two or microphones of one of the one or more ear-worn devices. In such embodiments, the system may determine that there is a fault if the levels are not within a certain range of each other (even if each of the levels are above a baseline). In other words, the system may determine that there is a fault if the two or more microphones are not well-matched.

In some embodiments, the system may average levels from multiple diagnostic tests prior to comparison to the baseline measurements. The multiple diagnostic tests may each be separated, for example, by at least a day in some embodiments, or by at least a week in some embodiments. This may help to average out variability in how the hearing aids are placed in the charging case, which may affect the level measurements. In some embodiments, the system may determine trends in levels, and determine that there is a fault based on the trends. For example, rather than determining that there is a fault based on a level measurement being at least a threshold lower than a baseline measurement, the system may determine that there is a fault based on levels being lower by increasing amounts over a certain period of time.

Step 1010 includes generating a notification. In some embodiments, the notification may be displayed on the display screen of the processing device. In some embodiments, the notification may be based on the fault. For example, if the fault relates to a microphone on one of the ear-worn devices, the notification may instruct the user to check and/or clean that microphone. As another example, if the fault relates to a receiver of one of the ear-worn devices, the notification may instruct the user to check and/or clean that microphone. In some embodiments, the notification may be generic; for example, the notification may be to check and/or clean all the microphones and receivers on both ear-worn devices.

In some embodiments, if the system determined at step 1008 that there was a fault, after generating the notification at step 1010, the system may provide an option (e.g., an option displayed on the display screen of the processing device) to repeat the diagnostic testing by repeating the process 1002.

In some embodiments, the system may be configured to modify its settings to compensate for the amount of degradation. For example, if the system determines that the outputted volume has degraded by a certain amount, the system may be configured to amplify the output by that same amount.

While the above description has described the example of two ear-worn devices each having two microphones and one receiver, other numbers for the ear-worn devices, microphones, and/or receivers may also be used. For example, an ear-worn device might only be diagnostically tested using a test sound signal generated by its own receiver and received by its own microphone(s). Thus, an embodiment of the process 1000 may include one test sound signal generated and received by multiple microphones. Another embodiment of the process 1000 may include one test sound signal generated and received by one microphone. In more detail, in some embodiments, a process may include generating a test sound signal from the receiver of an ear-worn device, receiving the test sound signal at microphones of the ear-worn device, determining levels of audio signals originating from the microphones based on receiving the test sound signal, determining if there is a fault, and if there is a fault, generating a notification. In some embodiments, a process may include generating a test sound signal from the receiver of an ear-worn device, receiving the test sound signal at the microphone of the ear-worn device, determining the level of the audio signal originating from the microphone based on receiving the test sound signal, determining if there is a fault, and if there is a fault, generating a notification.

In other words, diagnostic testing may be performed for one ear-worn device in a charging case. The process 1000 may be adapted to include generating at least one test sound signal from a receiver of the ear-worn device; receiving the at least one test sound signal at one or more microphones of the ear-worn device; determining at least one level of at least one audio signal originating from the one or more microphones of the ear-worn device based on receiving the at least one test sound signal; determining, based on the at least one level of the at least one audio signal originating from the one or more microphones of the ear-worn device, that there is a fault; and based on determining that there is the fault, generating a notification. Other methods and systems described herein may be adapted likewise for diagnostic testing of a single ear-worn device in a charging case.

If a wearer starts using new domes (e.g., the domes 148) and/or new receiver wires (e.g., the receiver wires 150) for their hearing aids, baseline measurements collected using the old domes and/or receiver wires may no longer be accurate. In some embodiments, the processing device may present an option to capture new baseline measurements. For example, the option may ask a user to select the option if new domes and/or receiver wires are being used. As another example, the processing device may receive an indication from the cloud that the wearer has received new domes and/or receiver wires, and present the option to capture new baseline measurements based on that indication. Upon selection of the option, the steps 1002-1006 may be performed, and the resulting level measurements may be saved (to the ear-worn devices, to the processing device, and/or to the cloud) as new baseline measurements.

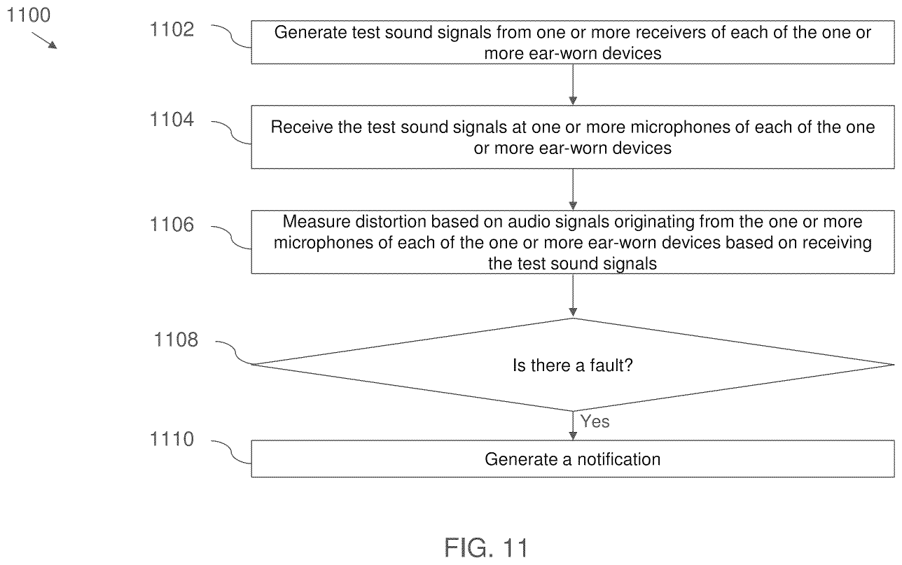

In some embodiments, in addition or alternatively to the diagnostic testing methods described above, the system may be configured to measure distortion. FIG. 11 illustrates a process 1100 for diagnostic testing of one or more ear-worn devices, in accordance with certain embodiments described herein. The ear-worn devices may be, for example, hearing aids. The hearing aids 100a and 100b and the ear-worn devices 500, 600, and 700 may be examples of the ear-worn devices diagnostically tested as part of the process 1100. The process 1100 may be performed by a system (e.g., the system 430) including one or more ear-worn devices, a charging case (e.g., the charging case 226 and/or 426), and a processing device (e.g., the processing device 432). The processing device may be, for example, a smartphone, tablet, or laptop. The ear-worn devices may be in wireless communication with the processing device over wireless communication links (e.g., the wireless communication links 434a and 434b), which may be, for example, Bluetooth or NFMI wireless communication links. The process 1100 may be performed while the ear-worn devices are in the charging case. Additionally, the process 1100 may be performed with the lid of the charging case closed.

Turning to FIG. 11, step 1102 of the process 1100 includes generating test sound signals (e.g., tones having a particular frequency) from one or more receivers (e.g., the receivers 104 and/or 504) of each of the one or more ear-worn devices. Further description may be found with reference to step 1002 of the process 1000.

Step 1104 of the process 1100 includes receiving the test sound signals at one or more microphones of each of the one or more ear-worn devices. Further description may be found with reference to step 1104 of the process 1100.

Step 1106 of the process 1100 includes measuring distortion based on audio signals originating from the one or more microphones of each of the one or more ear-worn devices based on receiving the test sound signals. In some embodiments, measuring distortion may include measuring the spectra of the audio signals and calculating total harmonic distortion (THD). Calculating THD may include calculating, from a spectrum, the ratio of the sum of the powers of all harmonic components (or in some cases, just the power of the second harmonic frequency) to the power of the fundamental frequency (where the fundamental frequency may be the frequency of the test signal). In some embodiments, the ear-worn device may measure the distortion. In some embodiments, the ear-worn device may transmit data (e.g., audio signals and/or their spectra) to the processing device, and the processing device may measure the distortion.

Step 1108 includes determining if there is a fault based on the distortion measurement. If the system determines that there is a fault, the process 1000 proceeds to step 1110. In some embodiments, the system may compare the distortion value to a pre-determined threshold value (e.g., 0.5%, 1%, 1.5%, 2%, etc.). In some embodiments, the ear-worn device may perform the comparison (e.g., using the processing circuitry 508) and transmit (e.g., using the communication circuitry 520) an indication of the comparison result to the processing device. In some embodiments, the processing device may perform the comparison.

Step 1110 includes generating a notification. In some embodiments, the notification may be displayed on the display screen of the processing device. In embodiments in which the fault relates to distortion exceeding a threshold value, the notification may instruct the user, for example, to contact customer support and/or obtain a replacement device.

As described above with reference to FIG. 10, it should be appreciated that alternative versions of the process 1100 may include one test sound signal generated and received by multiple microphones, or one test sound signal generated and received by one microphone.

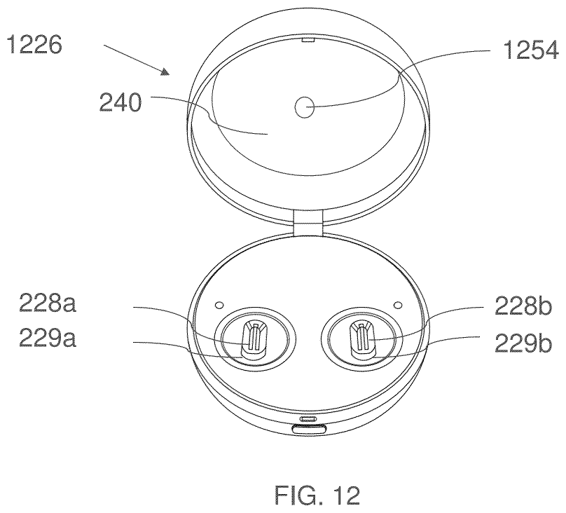

FIG. 12 illustrates a charging case 1226 for hearing aids, in accordance with certain embodiments described herein. The charging case 1226 may be configured for storage of hearing aids, carrying of hearing aids, and charging of hearing aids. The charging case 1226 may correspond to the charging case 226 (and further description of the charging case 1226 and its components may be found above with reference to FIGS. 2 and 3) except that the charging case 1226 additionally includes a speaker 1254 configured to generate sound. While FIG. 12 illustrates the speaker 1254 built into the lid 240 of the charging case 1226, it should be appreciated that the speaker 1254 may be built into any portion of the charging case 1226. While FIG. 12 illustrates that the charging case 1226 includes one microphone speaker 1254, it should be appreciated that the charging case 1226 may include one or more microphones.

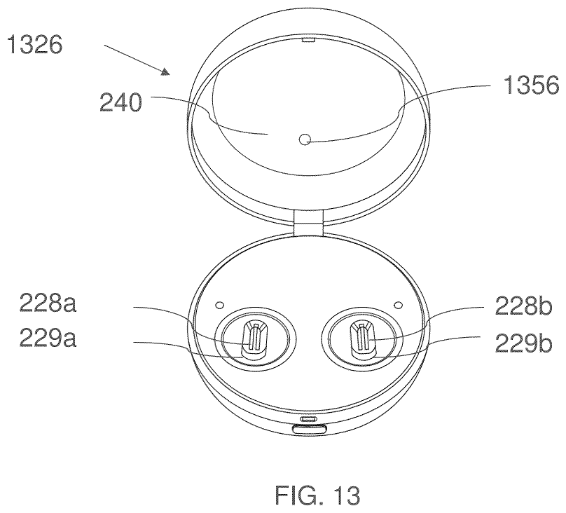

FIG. 13 illustrates a charging case 1326 for hearing aids, in accordance with certain embodiments described herein. The charging case 1326 may be configured for storage of hearing aids, carrying of hearing aids, and charging of hearing aids. The charging case 1326 may correspond to the charging case 226 (and further description of the charging case 1326 and its components may be found above with reference to FIGS. 2 and 3) except that the charging case 1326 additionally includes a microphone 1356 configured to receive sound and generate audio signals based on the sound. While FIG. 13 illustrates the microphone 1356 built into the lid 240 of the charging case 1326, it should be appreciated that the microphone 1356 may be built into any portion of the charging case 1326. While FIG. 13 illustrates that the charging case 1326 includes one microphone 1356, it should be appreciated that the charging case 1326 may include one or more microphones.

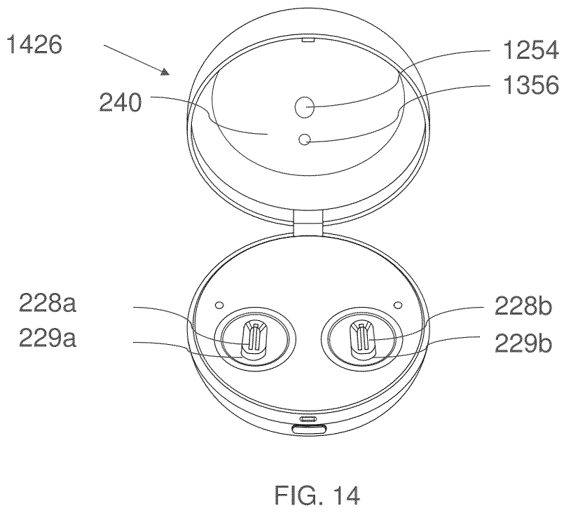

FIG. 14 illustrates a charging case 1426 for hearing aids, in accordance with certain embodiments described herein. The charging case 1426 may be configured for storage of hearing aids, carrying of hearing aids, and charging of hearing aids. The charging case 1426 may correspond to the charging cases 226, 1226, and 1326 (and further description of the charging case 1326 and its components may be found above with reference to FIGS. 2, 3, 12, and 13) except that the charging case 1426 includes the speaker 1254 and the microphone 1356.

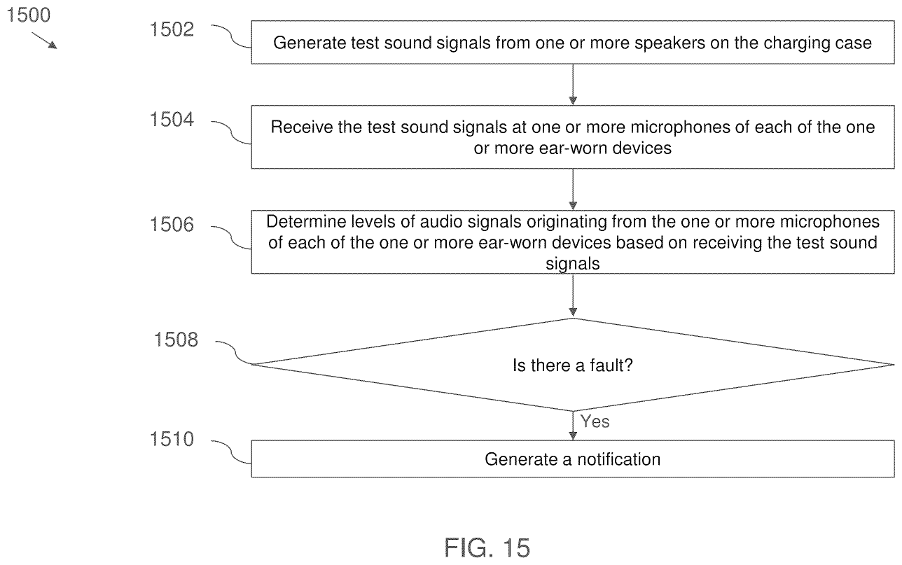

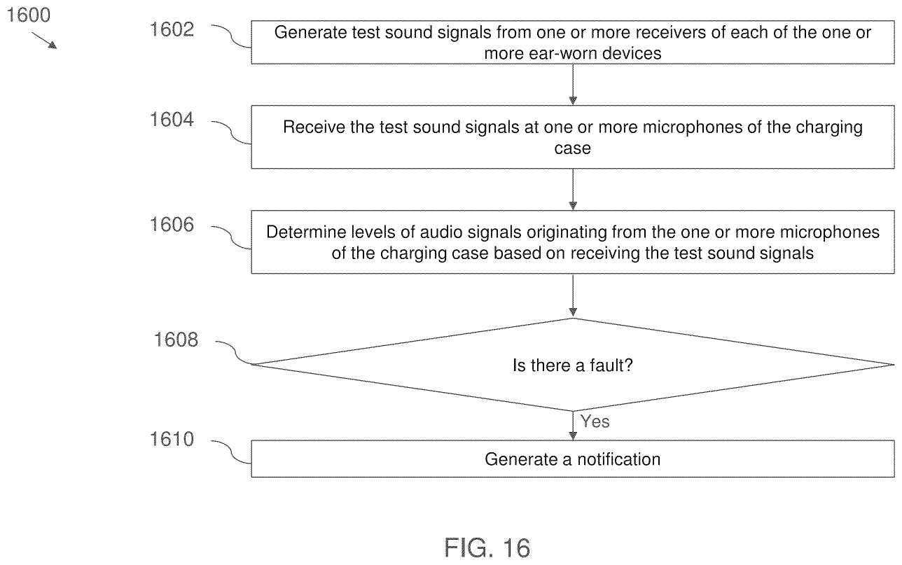

FIGS. 15 and 16 illustrate processes 1500 and 1600, respectively, for diagnostic testing of one or more ear-worn devices, in accordance with certain embodiments described herein. The ear-worn devices may be, for example, hearing aids. The hearing aids 100a and 100b and the ear-worn devices 500, 600, and 700 may be examples of the ear-worn devices diagnostically tested as part of the process 1000. The processes 1500 and 1600 may be performed by a system (e.g., the system 430) including one or more ear-worn devices, a charging case (e.g., the charging case 1226, 1326, and/or 1426), and a processing device (e.g., the processing device 432). The processing device may be, for example, a smartphone, tablet, or laptop. The ear-worn devices may be in wireless communication with the processing device over wireless communication links (e.g., the wireless communication links 434a and 434b), which may be, for example, Bluetooth or NFMI wireless communication links. The processes 1500 and 1600 may be performed while the ear-worn devices are in the charging case. Additionally, the processes 1500 and 1600 may be performed with the lid of the charging case closed.

Turning to FIG. 15, the process 1500 may correspond to the process 1000, except that the test sound signals are generated from one or more speakers (e.g., by the speaker 1254) on the charging case (e.g., the charging case 1226 and/or 1426). A speaker on the charging case may be a more reliable speaker than a receiver on an ear-worn device (e.g., in terms of its positioning in the charging case) and thus any faults detected may be more confidently attributed to issues with one or more microphones of the ear-worn devices.

Turning to FIG. 16, the process 1600 may correspond to the process 1000, except that the test sound signals are received at one or more microphones (e.g., the microphone 1356) of the charging case (e.g., the charging case 1326 and/or 1426) and the levels of audio signals originating from the one or more microphones of the charging case based on receiving the test sound signals are measured (e.g., using level measurement circuitry in the charging case corresponding to the level measurement circuitry 510). A microphone on the charging case may be a more reliable microphone than a microphone on an ear-worn device (e.g., in terms of its positioning in the charging case) and thus any faults detected based on audio signals generated by microphones of the ear-worn devices may be more confidently attributed to issues with one or more receivers of the ear-worn devices.

While the above description has described diagnostic testing ear-worn devices when they are in a charging case, in some embodiments other types of cases may be used, such as a carrying case not configured for charging.

This disclosure includes, at least, the following examples:

Example A1 is directed to a method comprising: diagnostically testing ear-worn devices by: generating test sound signals from receivers of the ear-worn devices; receiving the test sound signals at microphones of the ear-worn devices; determining levels of audio signals originating from the microphones of the ear-worn devices based on receiving the test sound signals; determining, based on the levels of the audio signals originating from the microphones of the ear-worn devices, that there is a fault; and based on determining that there is the fault, generating a notification.

Example A2 is directed to the method of example A1, wherein determining that there is the fault comprises determining whether one or more of the receivers of the ear-worn devices are faulty or whether one or more of the microphones of the ear-worn devices are faulty.

Example A3 is directed to the method of example A1, wherein determining that there is the fault comprises determining that one or more of the receivers of the ear-worn devices are faulty.

Example A4 is directed to the method of example A3, wherein: the ear-worn devices comprise a first ear-worn device and a second ear-worn device; the receivers comprise a first receiver of the first ear-worn device and a second receiver of the second ear-worn device; and determining that one or more of the receivers of the ear-worn devices are faulty comprises determining that the first receiver is faulty.

Example A5 is directed to the method of example A4, wherein determining that the first receiver is faulty comprises determining that the second receiver is not faulty.

Example A6 is directed to the method of example A1, wherein determining that there is the fault comprises determining that one or more of the microphones of the ear-worn devices are faulty.

Example A7 is directed to the method of example A6, wherein: the ear-worn devices comprise a first ear-worn device and a second ear-worn device; the microphones comprise one or more first microphones of the first ear-worn device and one or more second microphones of the second ear-worn device; and determining that one or more of the microphones of the ear-worn devices are faulty comprises determining that a first microphone among the one or more first microphones is faulty.

Example A8 is directed to the method of example A7, wherein determining that the first microphone among the one or more first microphones is faulty comprises determining that other microphones among the one or more first microphones and the one or more second microphones are not faulty.

Example A9 is directed to the method of example A7, wherein determining that the first microphone among the one or more first microphones is faulty comprises determining that a second microphone among the one or more first microphones is not faulty.

Example A10 is directed to the method of any of examples A1-A9, further comprising determining that the ear-worn devices are in a charging case.

Example A11 is directed to the method of any of examples A1-A10, further comprising determining that a lid of a charging case is closed.

Example A12 is directed to the method of any of examples A1-A11, further comprising determining that a volume of an environment within a charging case is below a threshold value.

Example A13 is directed to the method of any of examples A1-A12, wherein the test sound signals do not overlap temporally.

Example A14 is directed to the method of any of examples A1-A13, wherein determining that there is the fault comprises comparing the levels of the audio signals originating from the microphones of the ear-worn devices to previously-collected baseline levels.

Example A15 is directed to the method of example A14, wherein the baseline levels were collected before a wearer of the ear-worn devices wore the ear-worn devices.

Example A16 is directed to the method of any of examples A14-A15, wherein the baseline levels were collected before shipping of the ear-worn devices to a wearer of the ear-worn devices.

Example A17 is directed to the method of any of examples A1-A16, wherein determining the levels of the audio signals originating from the microphones of the ear-worn devices comprises using feedback cancellation circuitry of the ear-worn devices.

Example A18 is directed to the method of any of examples A1-A17, wherein determining that there is the fault comprises: performing a comparison of levels from two or more microphones on one of the ear-worn devices; and determining that the two or more microphones are not well-matched based on determining that the levels from the two or more microphones differ by at least a threshold amount.

Example A19 is directed to the method of any of examples A1-A18, further comprising averaging levels from multiple diagnostic tests each separated by at least one day.

Example A20 is directed to the method of any of examples A1-A19, wherein the method is for diagnostically testing the ear-worn devices when the ear-worn devices are in a charging case.

Example A21 is directed to the method of any of examples A1-A20, wherein: the ear-worn devices comprise a first ear-worn device and a second ear-worn device; and generating the test sound signals from the receivers of the ear-worn devices and receiving the test sound signals at the microphones of the ear-worn devices comprise: generating a first test sound signal from a first receiver of the first ear-worn device; receiving the first test sound signal at one or more first microphones of the first ear-worn device and at one or more second microphones of the second ear-worn device; and subsequent to generating and receiving the first test sound signal: generating a second test sound signal from a second receiver of the second ear-worn device; and receiving the second test sound signal at the one or more first microphones of the first ear-worn device and at the one or more second microphones of the second ear-worn device.

Example B1 is directed to a system comprising ear-worn devices, wherein the system is configured to diagnostically test the ear-worn devices by: generating test sound signals from receivers of the ear-worn devices; receiving the test sound signals at microphones of the ear-worn devices; determining levels of audio signals originating from the microphones of the ear-worn devices based on receiving the test sound signals; determining, based on the levels of the audio signals originating from the microphones of the ear-worn devices, that there is a fault; and based on determining that there is the fault, generating a notification.

Example B2 is directed to the system of example B1, wherein the system is configured, when determining that there is the fault, to determine whether one or more of the receivers of the ear-worn devices are faulty or whether one or more of the microphones of the ear-worn devices are faulty.

Example B3 is directed to the system of example B1, wherein the system is configured, when determining that there is the fault, to determine that one or more of the receivers of the ear-worn devices are faulty.

Example B4 is directed to the system of example B3, wherein: the ear-worn devices comprise a first ear-worn device and a second ear-worn device; the receivers comprise a first receiver of the first ear-worn device and a second receiver of the second ear-worn device; and the system is configured, when determining that one or more of the receivers of the ear-worn devices are faulty, to determine that the first receiver is faulty.

Example B5 is directed to the system of example B4, wherein the system is configured, when determining that the first receiver is faulty, to determine that the second receiver is not faulty.

Example B6 is directed to the system of example B1, wherein the system is configured, when determining that there is the fault, to determine that one or more of the microphones of the ear-worn devices are faulty.

Example B7 is directed to the system of example B6, wherein: the ear-worn devices comprise a first ear-worn device and a second ear-worn device; the microphones comprise one or more first microphones of the first ear-worn device and one or more second microphones of the second ear-worn device; and the system is configured, when determining that one or more of the microphones of the ear-worn devices are faulty, to determine that a first microphone among the one or more first microphones is faulty.

Example B8 is directed to the system of example B7, wherein the system is configured, when determining that the first microphone among the one or more first microphones is faulty, to determine that other microphones among the one or more first microphones and the one or more second microphones are not faulty.

Example B9 is directed to the system of example B7, wherein the system is configured, when determining that the first microphone among the one or more first microphones is faulty, to determine that a second microphone among the one or more first microphones is not faulty.

Example B10 is directed to the system of any of examples B1-B9, wherein the system further comprises a charging case, and the system is further configured to determine that the ear-worn devices are in the charging case.

Example B11 is directed to the system of any of examples B1-B10, wherein the system further comprises a charging case, and the system is further configured to determine that the lid of a charging case is closed.

Example B12 is directed to the system of any of examples B1-B11, wherein the system further comprises a charging case, and the system is further configured to determine that a volume of an environment within the charging case is below a threshold value.

Example B13 is directed to the system of any of examples B1-B12, wherein the test sound signals do not overlap temporally.

Example B14 is directed to the system of any of examples B1-B13, wherein the system is configured, when determining that there is the fault, to compare the levels of the audio signals originating from the microphones of the ear-worn devices to previously-collected baseline levels.

Example B15 is directed to the system of example B14, wherein the baseline levels were collected before a wearer of the ear-worn devices wore the ear-worn devices.

Example B16 is directed to the system of any of examples B14-B15, wherein the baseline levels were collected before shipping of the ear-worn devices to a wearer of the ear-worn devices.

Example B17 is directed to the system of any of examples B1-B16, wherein the system is configured, when determining the levels of the audio signals originating from the microphones of the ear-worn devices, to use feedback cancellation circuitry of the ear-worn devices.

Example B18 is directed to the system of any of examples B1-B17, wherein the system is configured, when determining that there is the fault, to: perform a comparison of levels from two or more microphones on one of the ear-worn devices; and determine that the two or more microphones are not well-matched based on determining that the levels from the two or more microphones differ by at least a threshold amount.

Example B19 is directed to the system of any of examples B1-B18, wherein the system is further configured to average levels from multiple diagnostic tests each separated by at least one day.

Example B20 is directed to the system of any of examples B1-B19, further comprising a charging case, and wherein the system is configured to diagnostically test the ear-worn devices when the ear-worn devices are in the charging case.

Example B21 is directed to the system of any of examples B1-B20, wherein: the ear-worn devices comprise a first ear-worn device and a second ear-worn device; and the system is configured, when generating the test sound signals from the receivers of the ear-worn devices and receiving the test sound signals at the microphones of the ear-worn devices, to: generate a first test sound signal from a first receiver of the first ear-worn device; receive the first test sound signal at one or more first microphones of the first ear-worn device and at one or more second microphones of the second ear-worn device; and subsequent to generating and receiving the first test sound signal: generate a second test sound signal from a second receiver of the second ear-worn device; and receive the second test sound signal at the one or more first microphones of the first ear-worn device and at the one or more second microphones of the second ear-worn device.

Example B22 is directed to the system of any of examples B1-B21, wherein the system further comprises a processing device in wireless communication with the ear-worn devices, and the processing device is configured to determine that there is the fault and generate the notification.

Example C1 is directed to a method comprising: diagnostically testing ear-worn devices by: generating at least one test sound signal from one or more speakers of a charging case; receiving the at least one test sound signals at microphones of the ear-worn devices; determining levels of audio signals originating from the microphones of the ear-worn devices based on receiving the at least one test sound signal; determining, based on the levels of the audio signals originating from the microphones of the ear-worn devices, that there is a fault; and based on determining that there is the fault, generating a notification.

Example C2 is directed to the method of example C1, wherein determining that there is the fault comprises determining that one or more of the microphones of the ear-worn devices are faulty.

Example C3 is directed to the method of example C2, wherein: the ear-worn devices comprise a first ear-worn device and a second ear-worn device; the microphones comprise one or more first microphones of the first ear-worn device and one or more second microphones of the second ear-worn device; and determining that one or more of the microphones of the ear-worn devices are faulty comprises determining that a first microphone among the one or more first microphones is faulty.

Example C4 is directed to the method of example C3, wherein determining that the first microphone among the one or more first microphones is faulty comprises determining that other microphones among the one or more first microphones and the one or more second microphones are not faulty.

Example C5 is directed to the method of example C3, wherein determining that the first microphone among the one or more first microphones is faulty comprises determining that a second microphone among the one or more first microphones is not faulty.

Example C6 is directed to the method of any of examples C1-C5, further comprising determining that the ear-worn devices are in the charging case.

Example C7 is directed to the method of any of examples C1-C6, further comprising determining that a lid of the charging case is closed.

Example C8 is directed to the method of any of examples C1-C7, further comprising determining that a volume of an environment within the charging case is below a threshold value.

Example C9 is directed to the method of any of examples C1-C8, wherein the at least one test sound signal comprises multiple test sound signals that do not overlap temporally.

Example C10 is directed to the method of any of examples C1-C9, wherein determining that there is the fault comprises comparing the levels of the audio signals originating from the microphones of the ear-worn devices to previously-collected baseline levels.

Example C11 is directed to the method of example C10, wherein the baseline levels were collected before a wearer of the ear-worn devices wore the ear-worn devices.

Example C12 is directed to the method of any of examples C10-C11, wherein the baseline levels were collected before shipping of the ear-worn devices to a wearer of the ear-worn devices.

Example C13 is directed to the method of any of examples C1-C12, wherein determining the levels of the audio signals originating from the microphones of the ear-worn devices comprises using feedback cancellation circuitry of the ear-worn devices.

Example C14 is directed to the method of any of examples C1-C13, wherein determining that there is the fault comprises: performing a comparison of levels from two or more microphones on one of the ear-worn devices; and determining that the two or more microphones are not well-matched based on determining that the levels from the two or more microphones differ by at least a threshold amount.

Example C15 is directed to the method of any of examples C1-C14, further comprising averaging levels from multiple diagnostic tests each separated by at least one day.

Example C16 is directed to the method of any of examples C1-C15, wherein the method is for diagnostically testing the ear-worn devices when the ear-worn devices are in a charging case.

Example D1 is directed to a system comprising ear-worn devices and a charging case for the ear-worn devices, wherein the system is configured to diagnostically test the ear-worn devices by: generating at least one test sound signal from one or more speakers of the charging case; receiving the at least one test sound signals at microphones of the ear-worn devices; determining levels of audio signals originating from the microphones of the ear-worn devices based on receiving the at least one test sound signal; determining, based on the levels of the audio signals originating from the microphones of the ear-worn devices, that there is a fault; and based on determining that there is the fault, generating a notification.

Example D2 is directed to the system of example D1, wherein the system is configured, when determining that there is the fault, to determine that one or more of the microphones of the ear-worn devices are faulty.

Example D3 is directed to the system of example D2, wherein: the ear-worn devices comprise a first ear-worn device and a second ear-worn device; the microphones comprise one or more first microphones of the first ear-worn device and one or more second microphones of the second ear-worn device; and the system is configured, when determining that one or more of the microphones of the ear-worn devices are faulty, to determine that a first microphone among the one or more first microphones is faulty.

Example D4 is directed to the system of example D3, wherein the system is configured, when determining that the first microphone among the one or more first microphones is faulty, to determine that other microphones among the one or more first microphones and the one or more second microphones are not faulty.

Example D5 is directed to the system of example D3, wherein the system is configured, when determining that the first microphone among the one or more first microphones is faulty, to determine that a second microphone among the one or more first microphones is not faulty.

Example D6 is directed to the system of any of examples D1-D5, wherein the system is further configured to determine that the ear-worn devices are in the charging case.

Example D7 is directed to the system of any of examples D1-D6, wherein the system is further configured to determine that a lid of the charging case is closed.

Example D8 is directed to the system of any of examples D1-D7, wherein the system is further configured to determine that a volume of an environment within the charging case is below a threshold value.

Example D9 is directed to the system of any of examples D1-D8, wherein the at least one test sound signal comprises multiple test sound signals that do not overlap temporally.

Example D10 is directed to the system of any of examples D1-D9, wherein the system is configured, when determining that there is the fault, to compare the levels of the audio signals originating from the microphones of the ear-worn devices to previously-collected baseline levels.

Example D11 is directed to the system of example D10, wherein the baseline levels were collected before a wearer of the ear-worn devices wore the ear-worn devices.

Example D12 is directed to the system of any of examples D10-D11, wherein the baseline levels were collected before shipping of the ear-worn devices to a wearer of the ear-worn devices.

Example D13 is directed to the system of any of examples D1-D12, wherein the system is configured, when determining the levels of the audio signals originating from the microphones of the ear-worn devices, to use feedback cancellation circuitry of the ear-worn devices.

Example D14 is directed to the system of any of examples D1-D13, wherein the system is configured, when determining that there is the fault, to: perform a comparison of levels from two or more microphones on one of the ear-worn devices; and determine that the two or more microphones are not well-matched based on determining that the levels from the two or more microphones differ by at least a threshold amount.

Example D15 is directed to the system of any of examples D1-D14, wherein the system is further configured to average levels from multiple diagnostic tests each separated by at least one day.

Example D16 is directed to the system of any of examples D1-D15, wherein the system is configured to diagnostically test the ear-worn devices when the ear-worn devices are in the charging case.

Example D17 is directed to the system of any of examples D1-D16, wherein the system further comprises a processing device in wireless communication with the ear-worn devices, and the processing device is configured to determine that there is the fault and generate the notification.

Example E1 is directed to a method comprising: diagnostically testing ear-worn devices by: generating test sound signals from receivers of the ear-worn devices; receiving the test sound signals at one or more microphones of a charging case; determining levels of audio signals originating from the one or more microphones of the charging case based on receiving the test sound signals; determining, based on the levels of the audio signals originating from the one or more microphones of the charging case, that there is a fault; and based on determining that there is the fault, generating a notification.

Example E2 is directed to the method of example E1, wherein determining that there is the fault comprises determining that one or more of the receivers of the ear-worn devices are faulty.

Example E3 is directed to the method of example E2, wherein: the ear-worn devices comprise a first ear-worn device and a second ear-worn device; the receivers comprise a first receiver of the first ear-worn device and a second receiver of the second ear-worn device; and determining that one or more of the receivers of the ear-worn devices are faulty comprises determining that the first receiver is faulty.

Example E4 is directed to the method of example E3, wherein determining that the first receiver is faulty comprises determining that the second receiver is not faulty.

Example E5 is directed to the method of any of examples E1-E4, further comprising determining that the ear-worn devices are in the charging case.

Example E6 is directed to the method of any of examples E1-E5, further comprising determining that a lid of the charging case is closed.

Example E7 is directed to the method of any of examples E1-E6, further comprising determining that a volume of an environment within the charging case is below a threshold value.

Example E8 is directed to the method of any of examples E1-E7, wherein the test sound signals do not overlap temporally.

Example E9 is directed to the method of any of examples E1-E8, wherein determining that there is the fault comprises comparing the levels of the audio signals originating from the one or more microphones of the charging case to previously-collected baseline levels.

Example E10 is directed to the method of example E9, wherein the baseline levels were collected before a wearer of the ear-worn devices wore the ear-worn devices.

Example E11 is directed to the method of any of examples E9-E10, wherein the baseline levels were collected before shipping of the ear-worn devices to a wearer of the ear-worn devices.

Example E12 is directed to the method of any of examples E1-E11, further comprising averaging levels from multiple diagnostic tests each separated by at least one day.

Example E13 is directed to the method of any of examples E1-E12, wherein the method is for diagnostically testing the ear-worn devices when the ear-worn devices are in a charging case.

Example F1 is directed to a system comprising ear-worn devices and a charging case for the ear-worn devices, wherein the system is configured to diagnostically test the ear-worn devices by: generating test sound signals from receivers of the ear-worn devices; receiving the test sound signals at one or more microphones of the charging case: determining levels of audio signals originating from the one or more microphones of the charging case based on receiving the test sound signals; determining, based on the levels of the audio signals originating from the one or more microphones of the charging case, that there is a fault; and based on determining that there is the fault, generating a notification.

Example F2 is directed to the system of example F1, wherein the system is configured, when determining that there is the fault, to determine that one or more of the receivers of the ear-worn devices are faulty.

Example F3 is directed to the system of example F2, wherein: the ear-worn devices comprise a first ear-worn device and a second ear-worn device; the receivers comprise a first receiver of the first ear-worn device and a second receiver of the second ear-worn device; and the system is configured, when determining that one or more of the receivers of the ear-worn devices are faulty, to determine that the first receiver is faulty.

Example F4 is directed to the system of example F3, wherein the system is configured, when determining that the first receiver is faulty, to determine that the second receiver is not faulty.

Example F5 is directed to the system of any of examples F1-F4, wherein the system is further configured to determine that the ear-worn devices are in the charging case.

Example F6 is directed to the system of any of examples F1-F5, wherein the system is further configured to determine that a lid of the charging case is closed.

Example F7 is directed to the system of any of examples F1-F6, wherein the system is further configured to determine that a volume of an environment within the charging case is below a threshold value.

Example F8 is directed to the system of any of examples F1-F7, wherein the test sound signals do not overlap temporally.

Example F9 is directed to the system of any of examples F1-F8, wherein the system is configured, when determining that there is the fault, to compare the levels of the audio signals originating from the one or more microphones of the charging case to previously-collected baseline levels.

Example F10 is directed to the system of example F9, wherein the baseline levels were collected before a wearer of the ear-worn devices wore the ear-worn devices.

Example F11 is directed to the system of any of examples E9-E10, wherein the baseline levels were collected before shipping of the ear-worn devices to a wearer of the ear-worn devices.

Example F12 is directed to the system of any of examples E1-E11, wherein the system is further configured to average levels from multiple diagnostic tests each separated by at least one day.

Example F13 is directed to the system of any of examples F1-F12, wherein the system is configured to diagnostically test the ear-worn devices when the ear-worn devices are in the charging case.

Example F14 is directed to the system of any of examples F1-F13, wherein the system further comprises a processing device in wireless communication with the ear-worn devices, and the processing device is configured to determine that there is the fault and generate the notification.

Example G1 is directed to a method comprising: diagnostically testing ear-worn devices by: generating test sound signals from receivers of the ear-worn devices; receiving the test sound signals at microphones of the ear-worn devices; measuring distortion based on audio signals originating from the microphones of the ear-worn devices based on receiving the test sound signals; determining, based on the distortion of the audio signals originating from the microphones of the ear-worn devices, that there is a fault; and based on determining that there is the fault, generating a notification.

Example G2 is directed to the method of example G1, wherein the method is for diagnostically testing the ear-worn devices when the ear-worn devices are in a charging case.

Example H1 is directed to a system comprising ear-worn devices, wherein the system is configured to diagnostically test the ear-worn devices by: generating test sound signals from receivers of the ear-worn devices; receiving the test sound signals at microphones of the ear-worn devices; measuring distortion based on audio signals originating from the microphones of the ear-worn devices based on receiving the test sound signals; determining, based on the distortion, that there is a fault; and based on determining that there is the fault, generating a notification.

Example H2 is directed to the system of example H1, further comprising a charging case, and wherein the system is configured to diagnostically test the ear-worn devices when the ear-worn devices are in the charging case.

Example H3 is directed to the system of any of examples H1-H2, wherein the system further comprises a processing device in wireless communication with the ear-worn devices, and the processing device is configured to determine that there is the fault and generate the notification.

Example I1 is directed to a charging case configured to charge one or more ear-worn devices, wherein the charging case comprises one or more speakers.

Example I2 is directed to the charging case of example I1, wherein the charging case further comprises one or more microphones.

Example J1 is directed to a charging case configured to charge one or more ear-worn devices, wherein the charging case comprises one or more microphones.

Example K1 is directed to a method comprising: diagnostically testing an ear-worn device by: generating at least one test sound signal from a receiver of the ear-worn device; receiving the at least one test sound signal at one or more microphones of the ear-worn device; determining at least one level of at least one audio signal originating from the one or more microphones of the ear-worn device based on receiving the at least one test sound signal; determining, based on the at least one level of the at least one audio signal originating from the one or more microphones of the ear-worn device, that there is a fault; and based on determining that there is the fault, generating a notification.

Example K2 is directed to the method of example K1, wherein determining that there is the fault comprises determining whether the receiver of the ear-worn device is faulty or whether one or more of the microphones of the ear-worn device are faulty.

Example K3 is directed to the method of any of examples K1-K2, further comprising determining that the ear-worn device is in a charging case.

Example K4 is directed to the method of any of examples K1-K3, further comprising determining that a lid of a charging case is closed.

Example K5 is directed to the method of any of examples K1-K4, further comprising determining that a volume of an environment within a charging case is below a threshold value.

Example K6 is directed to the method of any of examples K1-K5, wherein determining that there is the fault comprises comparing the at least one level of the at least one audio signal originating from the one or more microphones of the ear-worn device to one or more previously-collected baseline levels.

Example K7 is directed to the method of example K6, wherein the one or more baseline levels were collected before a wearer of the ear-worn device wore the ear-worn device.

Example K8 is directed to the method of any of examples K6-K7, wherein the one or more baseline levels were collected before shipping of the ear-worn device to a wearer of the ear-worn device.

Example K9 is directed to the method of any of examples K1-K8, wherein determining the at least one level of the at least one audio signal originating from the one or more microphones of the ear-worn device comprises using feedback cancellation circuitry of the ear-worn device.

Example K10 is directed to the method of any of examples K1-K9, wherein determining that there is the fault comprises: performing a comparison of levels from two or more microphones on the ear-worn device; and determining that the two or more microphones are not well-matched based on determining that the levels from the two or more microphones differ by at least a threshold amount.

Example K11 is directed to the method of any of examples K1-K10, further comprising averaging levels from multiple diagnostic tests each separated by at least one day.

Example K12 is directed to the method of any of examples K1-K11, wherein the method is for diagnostically testing the ear-worn device when the ear-worn device is in a charging case.

Example L1 is directed to a system comprising an ear-worn device, wherein the system is configured to diagnostically test the ear-worn device by: generating at least one test sound signal from a receiver of the ear-worn device; receiving the at least one test sound signal at one or more microphones of the ear-worn device; determining at least one level of at least one audio signal originating from the one or more microphones of the ear-worn device based on receiving the at least one test sound signal; determining, based on the at least one level of the at least one audio signal originating from the one or more microphones of the ear-worn device, that there is a fault; and based on determining that there is the fault, generating a notification.

Example L2 is directed to the system of example L1, wherein the system is configured, when determining that there is the fault, to determine whether the receiver of the ear-worn device is faulty or whether one or more of the microphones of the ear-worn device are faulty.

Example L3 is directed to the system of any of examples L1-L2, wherein the system further comprises a charging case, and the system is further configured to determine that the ear-worn device is in the charging case.

Example L4 is directed to the system of any of examples L1-L3, wherein the system further comprises a charging case, and the system is further configured to determine that a lid of the charging case is closed.

Example L5 is directed to the system of any of examples L1-L4, wherein the system further comprises a charging case, and the system is further configured to determine that a volume of an environment within the charging case is below a threshold value.

Example L6 is directed to the system of any of examples L1-L5, wherein the system is configured, when determining that there is the fault, to compare the at least one level of the at least one audio signal originating from the one or more microphones of the ear-worn device to one or more previously-collected baseline levels.

Example L7 is directed to the system of example L6, wherein the one or more baseline levels were collected before a wearer of the ear-worn device wore the ear-worn device.

Example L8 is directed to the system of any of examples L6-L7, wherein the one or more baseline levels were collected before shipping of the ear-worn device to a wearer of the ear-worn device.

Example L9 is directed to the system of any of examples L1-L8, wherein the system is configured, when determining the at least one level of the at least one audio signal originating from the one or more microphones of the ear-worn device, to use feedback cancellation circuitry of the ear-worn device.

Example L10 is directed to the system of any of examples L1-L9, wherein the system is configured, when determining that there is the fault, to: perform a comparison of levels from two or more microphones on the ear-worn device; and determine that the two or more microphones are not well-matched based on determining that the levels from the two or more microphones differ by at least a threshold amount.

Example L11 is directed to the system of any of examples L1-L10, wherein the system is further configured to average levels from multiple diagnostic tests each separated by at least one day.

Example L12 is directed to the system of any of examples L1-L11, further comprising a charging case, and wherein the system is configured to diagnostically test the ear-worn device when the ear-worn device is in the charging case.

Example L13 is directed to the system of any of examples L1-L13, wherein the system further comprises a processing device in wireless communication with the ear-worn devices, and the processing device is configured to determine that there is the fault and generate the notification.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. A system comprising ear-worn devices and a charging case, wherein the system is configured to diagnostically test the ear-worn devices when the ear-worn devices are in the charging case by:
generating test sound signals from receivers of the ear-worn devices;
receiving the test sound signals at microphones of the ear-worn devices;
determining levels of audio signals originating from the microphones of the ear-worn devices based on receiving the test sound signals;
determining, based on the levels of the audio signals originating from the microphones of the ear-worn devices, that there is a fault; and
based on determining that there is the fault, generating a notification.

2. The system of claim 1, wherein the system is configured, when determining that there is the fault, to determine whether one or more of the receivers of the ear-worn devices are faulty or whether one or more of the microphones of the ear-worn devices are faulty.

3. The system of claim 1, wherein the system is configured, when determining that there is the fault, to determine that one or more of the receivers of the ear-worn devices are faulty.

4. The system of claim 3, wherein:
the ear-worn devices comprise a first ear-worn device and a second ear-worn device;
the receivers comprise a first receiver of the first ear-worn device and a second receiver of the second ear-worn device; and
the system is configured, when determining that one or more of the receivers of the ear-worn devices are faulty, to determine that the first receiver is faulty.

5. The system of claim 4, wherein the system is configured, when determining that the first receiver is faulty, to determine that the second receiver is not faulty.

6. The system of claim 1, wherein the system is configured, when determining that there is the fault, to determine that one or more of the microphones of the ear-worn devices are faulty.

7. The system of claim 6, wherein:
the ear-worn devices comprise a first ear-worn device and a second ear-worn device;
the microphones comprise one or more first microphones of the first ear-worn device and one or more second microphones of the second ear-worn device; and
the system is configured, when determining that one or more of the microphones of the ear-worn devices are faulty, to determine that a first microphone among the one or more first microphones is faulty.

8. The system of claim 7, wherein the system is configured, when determining that the first microphone among the one or more first microphones is faulty, to determine that other microphones among the one or more first microphones and the one or more second microphones are not faulty.

9. The system of claim 7, wherein the system is configured, when determining that the first microphone among the one or more first microphones is faulty, to determine that a second microphone among the one or more first microphones is not faulty.

10. The system of claim 1, wherein the system is further configured to determine that the ear-worn devices are in the charging case.

11. The system of claim 1, wherein the system is further configured to determine that a lid of the charging case is closed.

12. The system of claim 1, wherein the system is further configured to determine that a volume of an environment within the charging case is below a threshold value.

13. The system of claim 1, wherein the test sound signals do not overlap temporally.

14. The system of claim 1, wherein the system is configured, when determining that there is the fault, to compare the levels of the audio signals originating from the microphones of the ear-worn devices to previously-collected baseline levels.

15. The system of claim 14, wherein the baseline levels were collected before a wearer of the ear-worn devices wore the ear-worn devices.

16. The system of claim 14, wherein the baseline levels were collected before shipping of the ear-worn devices to a wearer of the ear-worn devices.

17. The system of claim 1, wherein the system is configured, when determining the levels of the audio signals originating from the microphones of the ear-worn devices, to use feedback cancellation circuitry of the ear-worn devices.

18. The system of claim 1, wherein the system is configured, when determining that there is the fault, to:
perform a comparison of levels from two or more microphones on one of the ear-worn devices; and
determine that the two or more microphones are not well-matched based on determining that the levels from the two or more microphones differ by at least a threshold amount.

19. The system of claim 1, wherein the system is further configured to average levels from multiple diagnostic tests each separated by at least one day.

20. The system of claim 1, wherein:
the ear-worn devices comprise a first ear-worn device and a second ear-worn device; and
the system is configured, when generating the test sound signals from the receivers of the ear-worn devices and receiving the test sound signals at the microphones of the ear-worn devices, to:
generate a first test sound signal from a first receiver of the first ear-worn device;
receive the first test sound signal at one or more first microphones of the first ear-worn device and at one or more second microphones of the second ear-worn device; and
subsequent to generating and receiving the first test sound signal:
generate a second test sound signal from a second receiver of the second ear-worn device; and
receive the second test sound signal at the one or more first microphones of the first ear-worn device and at the one or more second microphones of the second ear-worn device.

21. The system of claim 1, wherein the system further comprises a processing device in wireless communication with the ear-worn devices, and the processing device is configured to determine that there is the fault and generate the notification.
